(19) United States
(12) Patent Application Publication
(10) Pub. No.: US 2026/0298371 A1
(43) Pub. Date: Oct. 1, 2026

(54) Marine Tubular Stabilizer And Protector

(71) Applicants: Chevron U.S.A. Inc., San Ramon, CA (US); Chevron Australia Pty Ltd, Perth (AU); Advanced Innergy Ltd, Gloucester (GB)

(72) Inventors: Antonio C.F. Critsinelis, Houston, TX (US); Leo George Caffrey, Houston, TX (US); Austin Harbison, Manchester (GB); Alireza Mazaheri, Cottesloe (AU); Dane Ryne Drew, Houston, TX (US); Menno Van Der Horst, Houston, TX (US); Sid Mebarkia, Houston, TX (US); Yiannis Constantinides, Katy, TX (US)

(21) Appl. No.: 19/479,288

(22) PCT Filed: Apr. 29, 2024
(86) PCT No.: PCT/US2024/026741

§ 371 Date: Oct. 27, 2025

Related U.S. Application Data
(60) Provisional application No. 63/499,209, filed on Apr. 28, 2023.

(51) Int. Cl. F16L 1/16

(52) U.S. Cl. CPC F16L 1/16

(57) ABSTRACT

A stabilizer attached to a marine tubular assists in inhibiting movement of the marine tubular when it is subjected to forces from ocean currents and waves encountered in subsea and shore crossing zones. The stabilizer includes a first plate and a second plate that are joined on opposite sides of the marine tubular. The stabilizer also includes one or more tubercles that extend from the stabilizer and inhibit motion of the marine tubular. A hydrodynamic shape of the one or more tubercles reduces drag as ocean currents flow over the stabilizer. The tubercle also can increase the moment arm of the stabilizer thereby inhibiting overturning of the stabilizer. The surfaces of the tubercle are shaped to promote the flow of ocean water below the stabilizer when the marine tubular is laid on a seabed or shore crossing zone.

### RELATED APPLICATIONS

The present application claims priority to U.S. Provisional Patent Application No. 63/499,209 filed Apr. 28, 2023, the entire content of which is incorporated herein by reference.

### TECHNICAL FIELD

Embodiments of the technology relate generally to a stabilizer for marine tubulars, including cables, umbilicals, and pipelines, that are placed in subsea and shoreline environments.

### BACKGROUND

The exploration for, extraction of, and transport of hydrocarbon resources from subsea reservoirs present many complex engineering challenges. Such exploration and extraction efforts involve the use of subsea and floating infrastructures with associated marine tubulars, including cables, umbilicals, and pipelines that extend along the seabed and connect to the subsea infrastructures. These marine tubulars are used for a variety of purposes including, but not limited to, for housing cables providing power, communication, and control signals. Maintaining reliable power and control signals for the subsea infrastructure is a critical function for ensuring continuous operation. The marine tubulars providing power and control signals typically connect to a power supply source or control center located either at an offshore platform (fixed or floating) or at an onshore facility.

The marine tubulars can be subjected to a variety of forces from ocean currents, waves, seabed changes, and vortex induced vibrations. The various forces encountered in the sea can cause the marine tubulars to shift and such movement can damage or dislocate the marine tubulars leading to rupture and can interrupt the power, communication, and control signals conveyed by the cables therein, as well as fluids that might be transported in the marine tubulars. This is a particular problem for the types of marine tubulars that house cables as they can be relatively small in diameter and can be made of lighter weight materials, such as polymers. However, these forces also can be a problem for larger or heavier pipelines that transport hydrocarbons. This problem is particularly acute where marine tubulars cross shorelines connecting to onshore facilities due to the forceful ocean currents and waves and shifting seabed often encountered in the shallow waters near shorelines. When power or control signals to a subsea infrastructure are interrupted, the loss of operating time can disrupt critical energy supplies and can involve substantial costs and challenges to rectify.

Existing approaches to stabilizing marine tubulars have a variety of shortcomings. For example, placing rock or pieces of cement on a marine tubular for stabilization can be very expensive and challenging, can cause damage to the marine tubular, can exacerbate erosion of the seabed around the marine tubular, and can be challenging to maintain and repair. Accordingly, improved approaches to stabilizing and protecting marine tubulars would be beneficial.

### SUMMARY

The following are example embodiments that will be illustrated and described in greater detail in the detailed description that follows.

One example embodiment is a stabilizer for a marine tubular that can comprise: (i) a first plate comprising an outer surface, an inner surface, a pair of longitudinal edges, and a pair of lateral edges, wherein the inner surface comprises a first channel extending along a longitudinal axis of the stabilizer, and wherein at least one longitudinal edge of the pair of longitudinal edges comprises a first plurality of tubercles extending from the at least one longitudinal edge; (ii) a second plate comprising an outer surface, an inner surface, a pair of longitudinal edges, and a pair of lateral edges, wherein the inner surface comprises a second channel extending along the longitudinal axis of the stabilizer; and (iii) a fastening mechanism that joins the first plate and the second plate about the marine tubular, wherein the marine tubular fits into the first channel of the first plate and the second channel of the second plate.

The foregoing stabilizer can have one or more of the following features. In the stabilizer, at least one longitudinal edge of the pair of longitudinal edges of the second plate can comprise a second plurality of tubercles extending from the at least one longitudinal edge of the second plate, and when the first plate and the second plate are joined by the fastening mechanism, the first plurality of tubercles and the second plurality of tubercles extend from opposite sides of the stabilizer. The stabilizer can be further described wherein the first plurality of tubercles form first ridges on the outer surface of the first plate, and wherein the second plurality of tubercles form second ridges on the outer surface of the second plate. The stabilizer can be further described wherein the first plurality of tubercles and the second plurality of tubercles extend in a perpendicular direction relative to the longitudinal axis of the stabilizer. The stabilizer can be further described wherein the first plurality of tubercles and the second plurality of tubercles are tapered to become more narrow as they extend away from the longitudinal edges of the first plate and the second plate. The stabilizer can be further described wherein the fastening mechanism that joins the first plate and the second plate about the undersea tubular is selected from the group of: fasteners inserted into the first plurality of tubulars and the second plurality of tubulars, fasteners inserted into the outer surface of the first plate, and a band wrapped around the first plate and the second plate, and wherein the fastening mechanism permits the stabilizer to rotate about the marine tubular when the stabilizer is attached to the marine tubular.

Another example embodiment is a method of stabilizing a marine tubular, wherein the method can comprise: (i) positioning a first plate on a first side of the marine tubular, wherein the first plate comprises an outer surface, an inner surface, a pair of longitudinal edges, and a pair of lateral edges, wherein the inner surface comprises a first channel extending along a longitudinal axis of the stabilizer, and wherein at least one longitudinal edge of the pair of longitudinal edges comprises a first plurality of tubercles extending from the at least one longitudinal edge; (ii) positioning a second plate on a second side of the marine tubular, wherein the second plate comprises an outer surface, an inner surface, a pair of longitudinal edges, and a pair of lateral edges, wherein the inner surface comprises a second channel extending along the longitudinal axis of the stabilizer; and (iii) attaching a fastening mechanism that joins the first plate and the second plate about the marine tubular, wherein the marine tubular fits into the first channel of the first plate and the second channel of the second plate.

The foregoing method can have one or more of the following features. In the foregoing method, the stabilizer can be placed onto the marine tubular on a tubular laying vessel before the marine tubular is deployed from the tubular laying vessel. In the foregoing method, the stabilizer can be placed onto the marine tubular before the marine tubular is loaded onto a tubular laying vessel for deployment. In the foregoing method, the stabilizer can be retrofitted onto a marine tubular that is located in the sea or at a shore crossing zone.

Another example embodiment is a stabilizer for a marine tubular, the stabilizer comprising: (i) a first plate comprising an outer surface, an inner surface, a pair of longitudinal edges, and a pair of lateral edges, wherein the inner surface comprises a first channel extending along a longitudinal axis of the tubular stabilizer, and wherein a longitudinal edge of the pair of longitudinal edges comprises a first flange; (ii) a second plate comprising an outer surface, an inner surface, a pair of longitudinal edges, and a pair of lateral edges, wherein the inner surface comprises a second channel extending along the longitudinal axis of the tubular stabilizer, and wherein a longitudinal edge of the pair of longitudinal edges comprises a second flange; and (iii) a tubercle assembly that wraps around the first plate and the second plate to join the first plate and the second plate about the marine tubular, wherein the marine tubular fits into the first channel of the first plate and the second channel of the second plate.

The foregoing stabilizer can have one or more of the following features. In the foregoing stabilizer, the tubercle assembly can extend horizontally from the pair of longitudinal edges of the first plate and the pair of longitudinal edges of the second plate when the marine tubular is laid on a seabed or shore zone crossing. In the foregoing stabilizer, the tubercle assembly can comprise a first fin and a second fin, wherein the first fin and the second fin extend vertically from the tubercle assembly permitting water to flow below the stabilizer when the marine tubular is laid on a seabed or shore zone crossing. In the foregoing stabilizer, a bottom surface of the tubercle assembly can have an inverted camber contour when the marine tubular with the attached stabilizer is laid on a seabed or shore crossing zone. In the foregoing stabilizer, the first plate can further comprise a first joint at a lateral edge of the first plate; the second plate can further comprise a second joint at a lateral edge of the second plate; and the tubercle assembly can wrap around the first joint and the second joint when joining the first plate and the second plate about the marine tubular. In the foregoing stabilizer, when joining the first plate and the second plate about the marine tubular, a longitudinal edge of the first plate fits into the second flange of the second plate; and a longitudinal edge of the second plate fits into the first flange of the first plate.

Another example embodiment is a method of stabilizing a marine tubular, wherein the method can comprise: (i) positioning a first plate on a first side of the marine tubular, wherein the first plate comprises an outer surface, an inner surface, a pair of longitudinal edges, and a pair of lateral edges, wherein the inner surface comprises a first channel extending along a longitudinal axis of the stabilizer, and wherein at least one longitudinal edge of the pair of longitudinal edges comprises a first flange; (ii) positioning a second plate on a second side of the marine tubular, wherein the second plate comprises an outer surface, an inner surface, a pair of longitudinal edges, and a pair of lateral edges, wherein the inner surface comprises a second channel extending along the longitudinal axis of the stabilizer; and (ii) attaching a tubercle assembly around the first plate and the second plate to join the first plate and the second plate about the marine tubular, wherein the marine tubular fits into the first channel of the first plate and the second channel of the second plate.

The foregoing method can include one or more of the following features. In the foregoing method, the stabilizer can be placed onto the marine tubular on a tubular laying vessel before the marine tubular is deployed from the tubular laying vessel. In the foregoing method, the stabilizer can be placed onto the marine tubular before the marine tubular is loaded onto a tubular laying vessel for deployment. In the foregoing method, the stabilizer can be retrofitted onto a marine tubular that is located in a sea or at a shore crossing zone. The foregoing method can further comprise: wherein, a third plate is attached to the marine tubular adjacent to the second plate; and a fourth plate attached to the marine tubular adjacent to the first plate. The foregoing method can further comprise: wherein, a third plate is attached to the marine tubular adjacent to the second plate; and a fourth plate is attached to the marine tubular adjacent to the first plate.

In another example embodiment, a stabilizer for a marine tubular can comprise: (i) a sleeve comprising an outer surface and an inner surface, the sleeve extending along a longitudinal axis of the stabilizer; (ii) a conduit located along the inner surface of the sleeve, the conduit arranged to contain the marine tubular; and (ii) a tubercle extending from a first longitudinal edge of the sleeve and from a second longitudinal edge of the sleeve, the tubercle extending in a direction perpendicular to the longitudinal axis of the stabilizer.

The foregoing example stabilizer can include one or more of the following features. In the foregoing stabilizer, the tubercle can comprise: a first fin disposed at a first end of the tubercle and a second fin disposed at a second end of the tubercle, the first end and the second being at opposing ends of the tubercle. In the foregoing stabilizer, the first fin and the second fin are oriented to penetrate into sand on which the stabilizer and the marine tubular rest. In the foregoing stabilizer, the stabilizer can slide onto the marine tubular. In the foregoing stabilizer, the stabilizer can snap onto the marine tubular.

Another example embodiment is a method of stabilizing a marine tubular that can comprise positioning a stabilizer on a marine tubular, the stabilizer comprising: (i) a sleeve comprising an outer surface and an inner surface, the sleeve extending along a longitudinal axis of the stabilizer; (ii) a conduit located along the inner surface of the sleeve, the conduit arranged to contain the marine tubular; and (iii) a tubercle extending from a first longitudinal edge of the sleeve and from a second longitudinal edge of the sleeve, the tubercle extending in a direction perpendicular to the longitudinal axis of the stabilizer.

The foregoing method can include one of the following features. In the foregoing method, the stabilizer can slide onto the marine tubular. In the foregoing method, the stabilizer can snap onto the marine tubular.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of apparatus and methods for marine tubular stabilizers and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates a marine tubular in the form of a cable crossing a shoreline to connect to an onshore facility in accordance with an example embodiment of the disclosure.

FIG. 2 illustrates a marine tubular stabilizer used to stabilize the marine tubular of FIG. 1 in accordance with an example embodiment of the disclosure.

FIG. 3 illustrates two plates of a stabilizer for a marine tubular in accordance with an example embodiment of the disclosure.

FIGS. 4 and 5 illustrate a method of attaching a stabilizer to a marine tubular in accordance with an example embodiment of the disclosure.

FIG. 6 illustrates a cross-sectional view of a stabilizer attached to a marine tubular in accordance with an example embodiment of the disclosure.

FIG. 7 illustrates another example of a stabilizer attached to a marine tubular in accordance with an example embodiment of the disclosure.

FIG. 8 illustrates another example of a stabilizer attached to a marine tubular in accordance with an example embodiment of the disclosure.

FIG. 9, FIG. 10, and FIG. 11 illustrate a method of attaching another stabilizer to a marine tubular in accordance with an example embodiment of the disclosure.

FIG. 12 illustrates a bottom view of the stabilizer of FIGS. 9-11 in accordance with an example embodiment of the disclosure.

FIG. 13 illustrates yet another example of a stabilizer attached to a marine tubular in accordance with an example embodiment of the disclosure.

FIG. 14 illustrates yet another example of a stabilizer attached to a marine tubular in accordance with an example embodiment of the disclosure.

FIG. 15 illustrates yet another example of a stabilizer attached to a marine tubular in accordance with an example embodiment of the disclosure.

### DETAILED DESCRIPTION OF EXAMPLE EMBODIMENTS

The example embodiments discussed herein are directed to apparatus and methods for a marine tubular stabilizer that addresses one or more of the previously identified challenges. As used herein, a marine tubular includes: a) a cable or umbilical for power, control, or communications signals, b) a housing or conduit that encloses such a cable or umbilical, and c) pipelines, including rigid, flexible, and thermoplastic composite pipelines, that encompass cables and equipment or that transport oil, gas, hydrogen, or other fluids. The example stabilizers described herein can be used to stabilize any of the foregoing examples of marine tubulars.

The advantages of the marine tubular stabilizer described herein will be illustrated in greater detail in connection with the example embodiments described below. Briefly, the disclosed stabilizer can provide one or more of the following advantages. The disclosed stabilizer is flexible in that it can be easily attached to marine tubulars before they are deployed in the sea to connect infrastructure or the stabilizer can be retrofitted easily onto marine tubulars that have already been deployed or installed in the sea. One aspect of the flexibility of the example stabilizers described herein is that they are adaptable for passing through various installation vessels' tensioner, roller, stinger and chute during installation of a marine tubular. The marine tubular stabilizer described herein can provide a hydrodynamic shape that minimizes drag as ocean currents and waves pass over the marine tubular and the stabilizer. Additionally, the disclosed stabilizer can facilitate flow of water beneath the stabilizer to inhibit lift forces on the stabilize that might cause it to shift or overturn. The disclosed stabilizer can provide an increased moment arm that also inhibits shifting and overturning of the stabilized marine tubular. The simplicity and effectiveness of the disclosed stabilizer can aid in avoiding the challenges and expenses associated with marine tubulars that have been dislocated or disconnected from infrastructure. In addition to stabilization, the stabilizers described herein also can protect the tubulars to which they are attached from damage caused by contact with other objects or corrosion.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

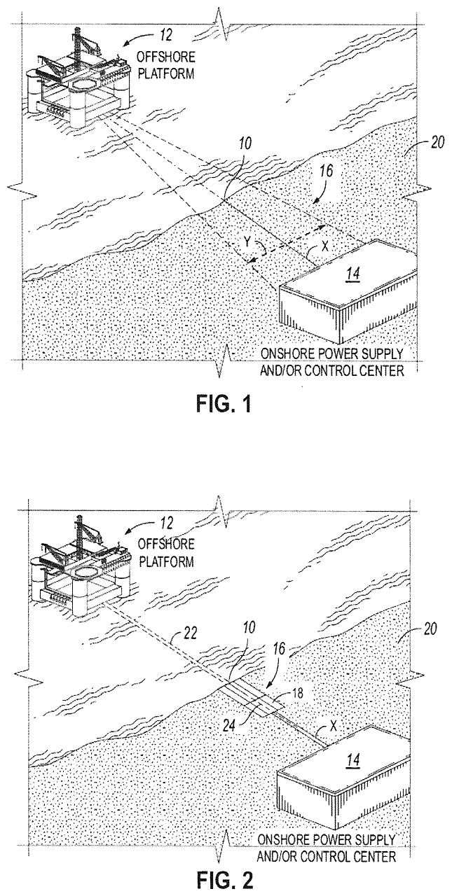

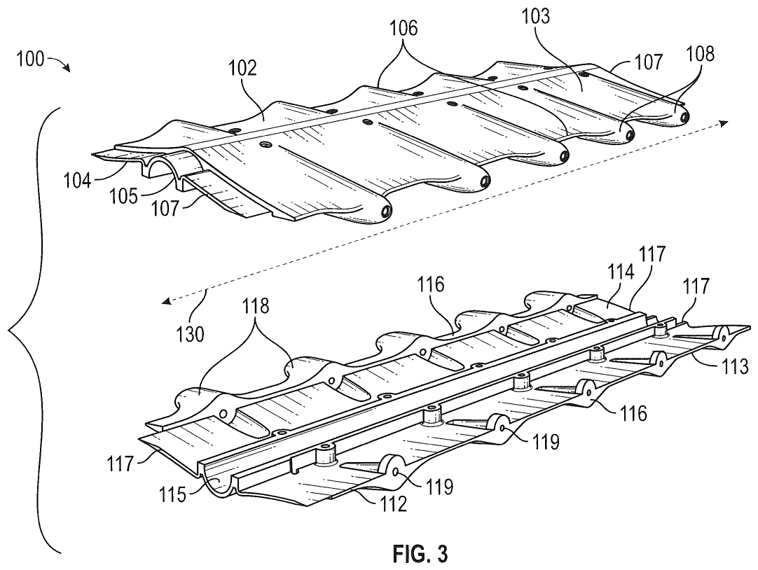

FIGS. 1 and 2 illustrate an example application of the stabilizer described herein. FIGS. 1 and 2 illustrate an example of energy infrastructure in the form of an offshore platform 12 floating in the ocean. The example stabilizers described herein can be used with a variety of energy infrastructure located in a body of water, including hydrocarbon platforms, a subsea facility, an offshore windfarm, an offshore wave generator, an undersea power interconnector, a power supply, a control center, or any combination thereof. FIGS. 1 and 2 show the offshore platform 12 (a first energy infrastructure installation), which can be any floating or fixed platform, connected to a power supply or control center 14 (a second energy infrastructure installation) via a cable (a marine tubular) 10. The cable 10 traverses a shore crossing zone 16. As used herein, a shore crossing zone can be a shoreline or a shallow water area in any body of water where the challenges presented by a shifting seabed or strong ocean currents or waves can be particularly acute. The conditions present at shore crossing zone 16 may impart hydrodynamic forces on the cable 10 that cause the cable 10 to move in the Y direction as illustrated in FIG. 1. While these forces can be particularly acute in shore crossing zones, tubulars in deeper waters or other marine environments such as river crossings also can be subjected to a variety of forces and the stabilizers described herein can be beneficial in those environments as well.

In FIG. 2, a stabilizer 18, in accordance with the examples provided herein, has been applied to cable 10 to stabilize the cable in the shore crossing zone 16. The stabilizer 18 has been applied so that its longitudinal axis 24 is oriented in the X direction in an intersecting matter crosswise (e.g., perpendicular) to the shoreline 20. The stabilizer 18 can be applied to the cable 10 at the shoreline 20 as well as in the shallow water of the shore crossing zone 16. In other embodiments, the stabilizer 18 also can be applied to the cable along the cable route 22 in deeper waters than those encountered at a shore crossing zone to counteract forces from waves, bottom currents, or a shifting seabed.

The stabilizer 18 can have one or more features that improve its effectiveness in stabilizing the cable 10. Additionally, the features of the stabilizer can be selected based upon the particular environment in which the marine tubular is located. As one example, the shape of the stabilizer can be tapered to reduce drag from the hydrodynamic forces on the cable 10 and thereby inhibit motion of the cable in the horizontal direction (the Y direction) and/or vertical motion that would lift the cable 10 from the shoreline. In certain examples, the shape of the stabilizer inhibits lift and/or increases the moment arm of the stabilizer to inhibit motion. As another example, the stabilizer can have features such as one or more fins that penetrate into a sandy shoreline to enhance stabilization. As yet another example, the stabilizer can have features that adhere to a rocky shoreline or rocky subsea area. A plurality of the foregoing features can be combined to improve the performance of the stabilizer. By inhibiting motion of the cable (marine tubular), the stabilizer increases the longevity of the energy infrastructure and reduces the frequency of repairs, interventions, and potential loss or halting of energy production. As an additional benefit, the stabilizer can protect the tubular against impacts from other objects and can inhibit corrosion.

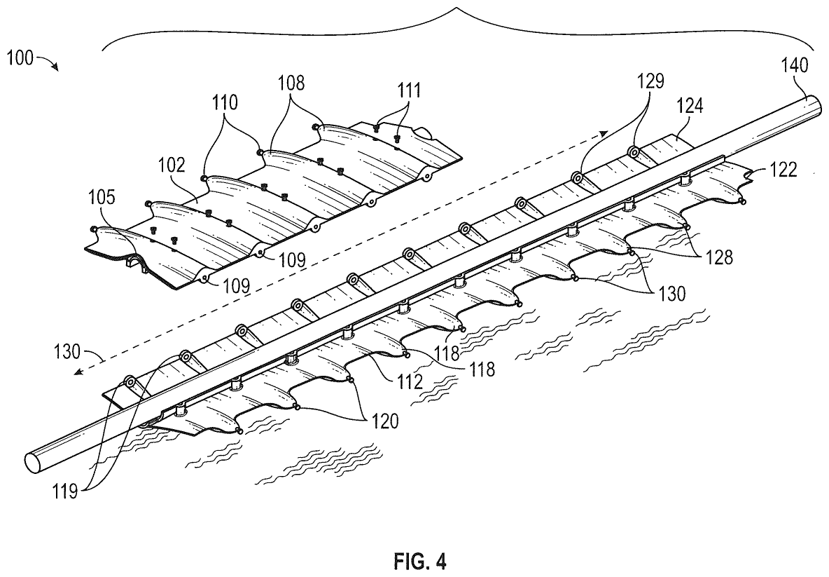

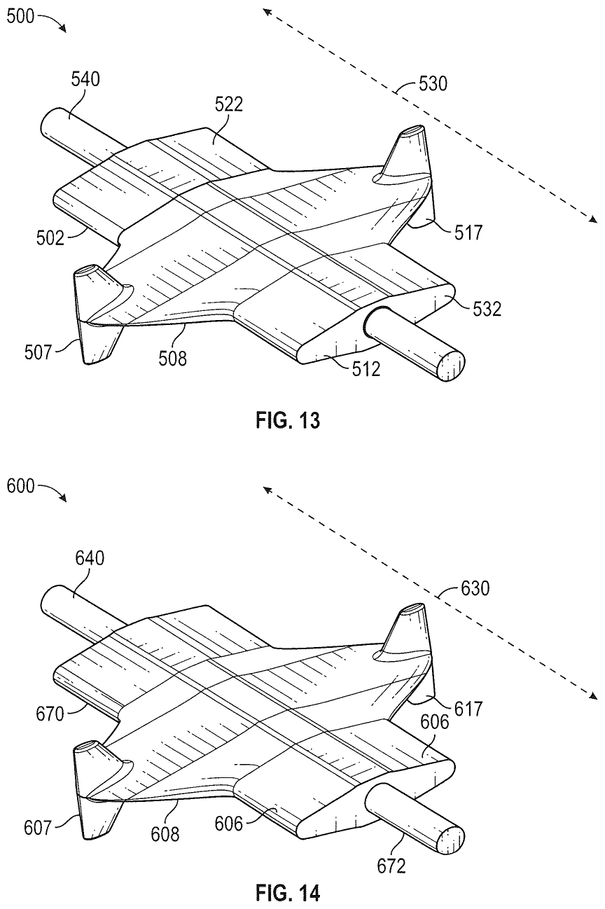

FIGS. 3-6 illustrate a first example embodiment of a stabilizer for a marine tubular that can be applied in an environment such as that illustrated in FIGS. 1 and 2. As used herein, a stabilizer can refer to: 1) a pair of plates as illustrated in FIGS. 3, 2) a single device that surrounds the tubular as illustrated in FIG. 14, or 3) a system of multiple devices or multiple pairs of plates attached along a length of a marine tubular as illustrated in subsequent figures herein.

FIG. 3 illustrates features of stabilizer 100 before it is attached to a marine tubular. Stabilizer 100 comprises a first plate 102 that has an outer surface 103, an inner surface 104, a pair of opposing lateral edges 107 on the shorter ends of the first plate 102, and a pair of longitudinal edges 106 on the longer ends of the first plate 102. The inner surface 104 includes a first channel 105 that runs along the longitudinal axis 130 of the stabilizer 100 and into which a portion of a marine tubular can fit. While the first channel 105 is shown as having a semicylindrical shape, in other examples the first channel can take other forms such as a gap defined by protrusions on the inner surface 104 wherein a marine tubular fits within the gap. The first plate 102 also comprises a plurality of first tubercles 108, which can also be referred to as protrusions or projections, that extend from one of the longitudinal edges.

The stabilizer also comprises a second plate 112 that is generally identical to the first plate. In the illustration of FIG. 3, the second plate 112 has been turned over and rotated 180 degrees relative the first plate 102. Similar to the description of the first plate 102, the second plate 112 comprises an outer surface 113, an inner surface 114, a pair of opposing lateral edges 117 on the shorter ends of the second plate 112, and a pair of longitudinal edges 116 on the longer ends of the second plate 112. The inner surface 114 includes a second channel 115 that runs along the longitudinal axis 130 of the stabilizer 100 and into which a portion of a marine tubular can fit. As with the description of the first channel 105, the second channel 115 is shown as having a semicylindrical shape, but in other examples the second channel can take other forms such as a gap defined by protrusions on the inner surface 114 wherein a marine tubular fits within the gap. The second plate 112 also comprises a plurality of second tubercles 118, which can also be referred to as protrusions or projections, that extend from one of the longitudinal edges. Visible on the inner surface 114 of the second plate 112 are a plurality of second joints 119. While not visible in FIG. 3, the first plate 102 has a similar plurality of joints along the inner surface 104. As will be described further, the joints on each plate align with the tubercles on the opposing plate when the first plate 102 and the second plate 112 are joined.

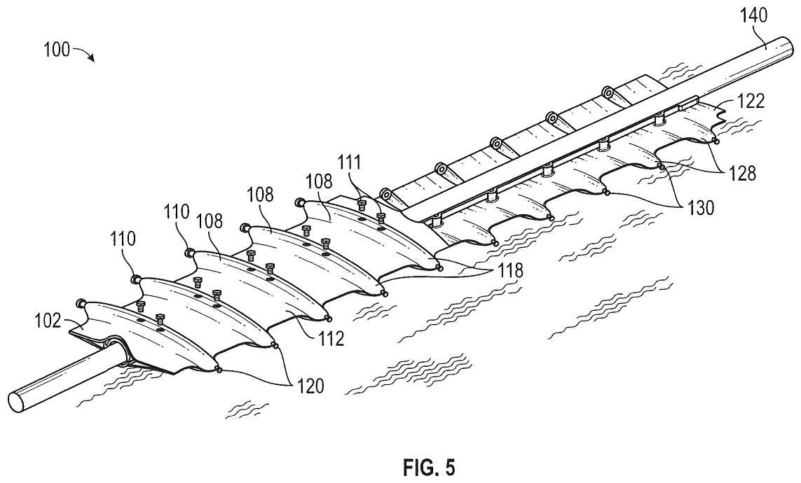

FIGS. 4 and 5 illustrate an example method for attaching a stabilizer to a marine tubular in accordance with an example embodiment. It should be understood that the method illustrated in FIGS. 4 and 5 is a non-limiting example and in alternate embodiments a stabilizer can be attached to a marine tubular using other methods or using operations that are performed in a different sequence than described in the example.

FIGS. 4 and 5 show a marine tubular 140 to which a stabilizer is attached. The flexible design of the stabilizer facilitates attachment to a marine tubular in a variety of environments, including onboard a cable (tubular) laying vessel, at a staging area where a tubular is prepared for laying, or in a retrofit of a tubular that is already located on a seabed or in a shore crossing zone. In a first operation, the second plate 112 is placed on one side of the marine tubular 140 so that the tubular 140 fits into the second channel 115 of the second plate 112. The tubular 140 may need to be lifted by workers and/or with mechanical devices to slide the second plate 112 under the tubular 140. In a retrofit operation in which a stabilizer is attached to a tubular that is already on the seabed, a remotely operated vehicle can be used in attaching the stabilizer to the tubular. In a second operation, a first plate 102 is placed onto the tubular 140 opposite the second plate 112 so that the tubular 140 fits into the first channel 105 of the first plate 102. The first channel 105 and the second channel 115 assist in securing the tubular and inhibiting movement of the tubular 140 within the stabilizer 100. Once the first plate 102 and second plate 112 are joined about the tubular 140, the longitudinal axis 130 of the stabilizer is aligned with and coincides with the longitudinal axis of the tubular 140.

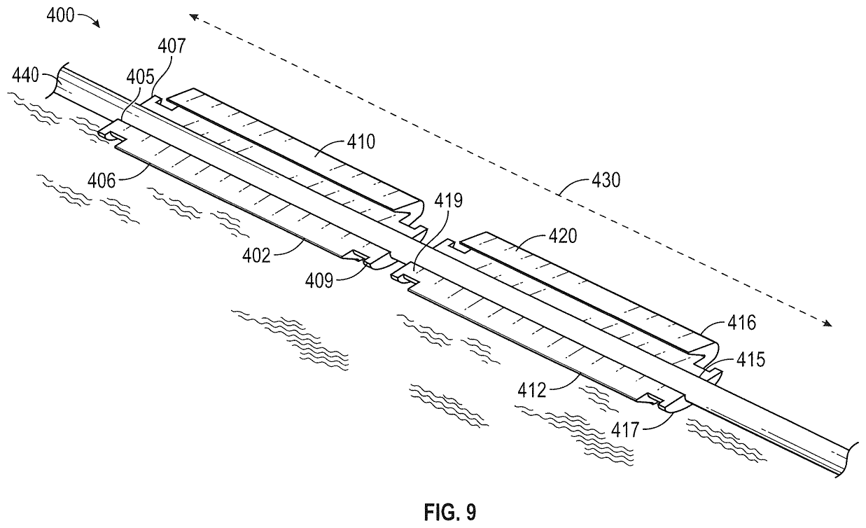

In a third operation, a fastening mechanism is applied to the stabilizer 100 to secure the first plate 102 and the second 112 together with the marine tubular 140 therein. A variety of fastening mechanisms can be used to secure the two plates together. The example of FIGS. 4 and 5 illustrates vertical fasteners (e.g., screws or pins) that pass into the outer surface 103 of the first plate 102 and lock into the inner surface 114 of the second plate 112. The example of FIGS. 4 and 5 also uses horizontal fasteners 110 that pass into the plurality of tubercles 108, 118 and lock into the joints 109, 119 of the opposing plate. Another example of a fastener that can be used to join the two plates is a band that wraps around the two plates as illustrated in the example of FIG. 8. Preferably, the opposing plates are fastened so that they can freely rotate about the tubular to minimize twisting of or damage to the tubular. In other words, the opposing plates are fastened so that they do not crimp the tubular.

As illustrated in FIGS. 4 and 5 additional plates can be placed along the tubular to provide further stabilization. The additional plates can be placed immediately adjacent to already attached plates or can spaced out axially along the tubular. FIGS. 4 and 5 show a third plate 122 that is similar to the first and second plates. The third plate 122 comprises an outer surface (not visible), an inner surface 124, a pair of opposing lateral edges on the shorter ends of the third plate 122, and a pair of longitudinal edges on the longer ends of the third plate 122. The inner surface 124 includes a third channel that runs along the longitudinal axis 130 of the stabilizer 100 and into which a portion of the marine tubular 140 can fit. The third plate 122 also comprises a plurality third tubercles 128, which can also be referred to as protrusions or projections, that extend from one of the longitudinal edges. Visible on the inner surface 114 of the second plate 112 are a plurality of third joints 129. A fourth plate can be joined to the third plate 122 in a manner similar to the first and second plates using fasteners 130.

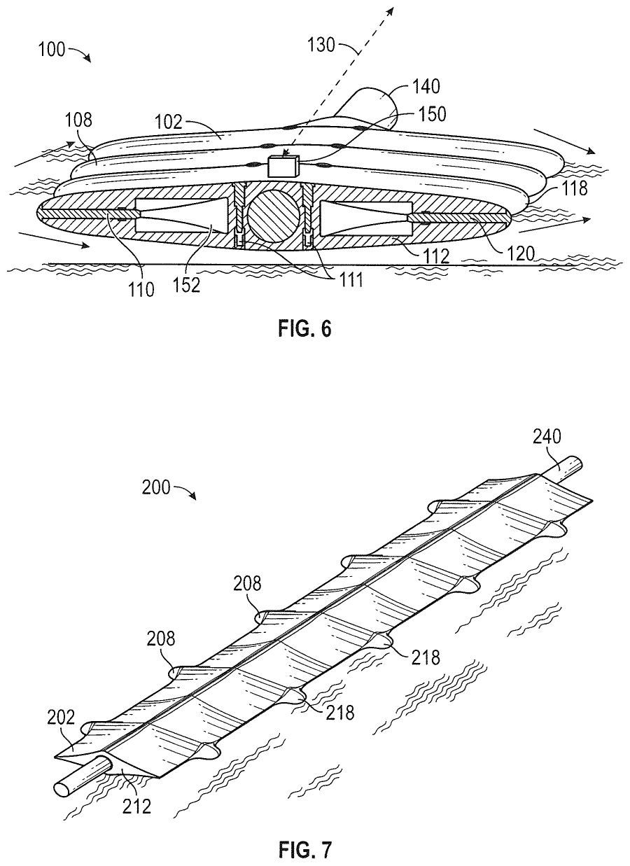

FIG. 6 illustrates advantages that the example stabilizers described herein can provide for marine tubulars. FIG. 6 shows a cross section of example stabilizer 100 after it has been attached to marine tubular 140. The tubular 140 and stabilizer 100 are located on a seabed or in a shore crossing zone. The stabilizer 100 and the tubercles 108 and 118 extending from the stabilizer 100 have a hydrodynamic shape that minimizes drag from ocean currents passing over the stabilizer by having smooth surfaces and by tapering to become more narrow as the tubercles and surfaces extend outward away from the longitudinal axis 130. In the example of FIGS. 3-6, the contour of each tubercle forms a ridge that extends perpendicularly across the longitudinal axis 130 from one longitudinal edge to the opposite longitudinal edge of the stabilizer 100. These ridges of the tubercles can promote the flow of ocean currents both over the top and under the bottom of the stabilizer 100 thereby inhibiting lift forces which could cause the stabilizer to move. In some embodiments, the ridges formed by the tubercles can be pronounced so that they settle into a sandy bottom to further promote stability.

The stabilizer 100 also is designed to increase the moment arm of the stabilizer to further inhibit movement or overturning of the stabilizer. The moment arm is increased by having hollow cavities 152 near the longitudinal axis 130 of the stabilizer while increasing weight at the ends of the tubercles farthest from the longitudinal axis 130. In certain example embodiments, the fasteners 110 and 120 can be weighted dowels that add to the weight at the ends of the tubercles farthest from the longitudinal axis 130.

The stabilizer 100 also can include one more sensors, such as sensor 150. The sensors can be any of a variety of sensors including accelerometers or pressure sensors that can provide information concerning the movement of the stabilizer and the stabilizer environment. The sensors can be located at various positions on the surface or within the stabilizer. As one example, a remotely operated vehicle can pass by the stabilizer and collect data from the one or more sensors for return and analysis at a platform or control center.

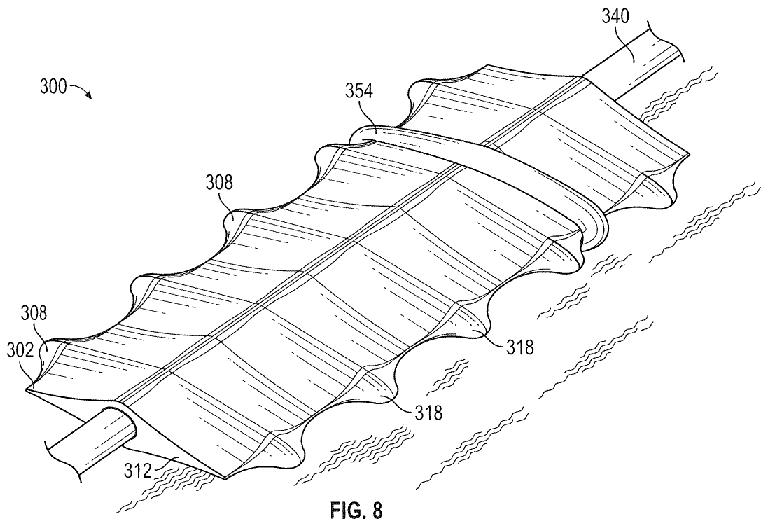

FIGS. 7 and 8 illustrate alternate embodiments that are similar to the stabilizer 100 of FIGS. 3-6. The alternate embodiments of FIGS. 7 and 8 differ from the previous embodiment in the spacing between the tubercles and the contours of the longitudinal edges, however, the principles of operation of the stabilizers of FIGS. 7 and 8 are generally similar to the stabilizer of FIGS. 3-6. Accordingly, the previous description of the features of stabilizer 100 can apply to the stabilizers illustrated in FIGS. 7 and 8.

FIG. 7 shows a stabilizer 200 attached to a marine tubular 240. As in the previous description, the stabilizer 200 can be attached to the marine tubular 240 in a variety of settings, including at a staging area, on a tubular laying vessel, or in a retrofit to a marine tubular that is already located on a seabed or a shore crossing area. The stabilizer 200 comprises a first plate 202 attached to a second plate 212 on opposite sides of the tubular 240. The first plate 202 and the second plate 212 generally have the same shapes and surfaces on their outer and inner surfaces. The stabilizer 200 also comprises a plurality of tubercles (projections) 208 and 218 extending from the longitudinal edges of the stabilizer 200. As can be seen in FIG. 7, the first and second plate and the plurality of tubercles have hydrodynamic contoured surfaces that minimize drag as ocean currents pass over the stabilizer. The tubercles 208 and 218 promote stability by allowing water to flow under the stabilizer and by distributing weight towards the longitudinal edges of the stabilizer.

FIG. 8 shows another stabilizer 300 attached to a marine tubular 340. As in the previous description, the stabilizer 300 can be attached to the marine tubular 340 in a variety of settings, including at a staging area, on a tubular laying vessel, or in a retrofit to a marine tubular that is already located on a seabed or a shore crossing area. The stabilizer 300 comprises a first plate 302 attached to a second plate 312 on opposite sides of the tubular 340. The first plate 302 and the second plate 312 generally have the same shapes and surfaces on their outer and inner surfaces. The stabilizer 300 also comprises a plurality of tubercles (projections) 308 and 318 extending from the longitudinal edges of the stabilizer 300. As can be seen in FIG. 8, the first and second plate and the plurality of tubercles have hydrodynamic contoured surfaces that minimize drag as ocean currents pass over the stabilizer. The tubercles 308 and 318 promote stability by allowing water to flow under the stabilizer and by distributing weight towards the longitudinal edges of the stabilizer.

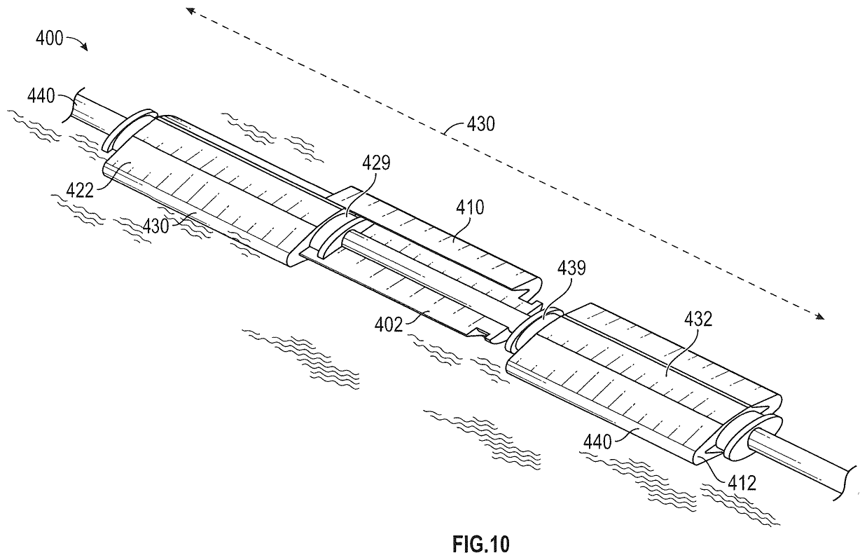

FIGS. 9-12 illustrate another embodiment of a stabilizer for a marine tubular showing both the features of the stabilizer and a method for attaching the stabilizer to a marine tubular. Stabilizer 400 comprises a first plate 402 that has an outer surface, an inner surface, a pair of opposing lateral edges 407 on the shorter ends of the first plate 402, and a pair of longitudinal edges 406 on the longer ends of the first plate 402. Similar to the previous embodiments, the inner surface includes a first channel 405 that runs along the longitudinal axis 430 of the stabilizer 400 and into which a portion of a marine tubular can fit. The first channel 405 can have a semicylindrical shape or other similar shapes configured to secure a marine tubular. One of the longitudinal edges 406 can comprise a first flange 410 that is used to join two plates together. One or both of the lateral edges 407 on opposite shorter ends of the first plate 402 can have a first joint 409.

While not required to have an adjacent set of plates, in the example stabilizer 400 includes an adjacent plate referred to as a second plate 412 that is generally similar in shape to first plate 402. The second plate 412 that has an outer surface, an inner surface, a pair of opposing lateral edges 417 on the shorter ends of the second plate 412, and a pair of longitudinal edges 416 on the longer ends of the second plate 412. Similar to the previous embodiments, the inner surface includes a second channel 415 that runs along the longitudinal axis 430 of the stabilizer 400 and into which a portion of a marine tubular can fit. The second channel 415 can have a semicylindrical shape or other similar shapes configured to secure a marine tubular. One of the longitudinal edges 416 can comprise a second flange 420 that is used to join two plates together. One or both of the lateral edges 417 on opposite shorter ends of the second plate 412 can have a second joint 419.

FIG. 10 illustrates a third plate 422 being joined to the first plate 402 and a fourth plate 432 that has been joined to the second plate 412 to form the stabilizer 400. The third plate 422 and fourth plate 432 are generally similar to the first plate 402 and the second plate 412. The third plate 422 has an outer surface, an inner surface, a pair of opposing lateral edges on the shorter ends of the third plate 422, a pair of longitudinal edges on the longer ends of the third plate 422, and a third channel on the inner surface along the longitudinal axis 430 of the stabilizer 400. Similarly, the fourth plate 432 has an outer surface, an inner surface, a pair of opposing lateral edges on the shorter ends of the fourth plate 432, a pair of longitudinal edges on the longer ends of the fourth plate 432, and a fourth channel on the inner surface along the longitudinal axis 430 of the stabilizer 400. Also similar to the first and second plate, the third plate 422 has a third flange 430 along one of its longitudinal edges and a third joint 429 along at least one lateral edge. Likewise, the fourth plate 432 has a fourth flange 440 along one of its longitudinal edges and a fourth joint 439 along at least one lateral edge.

In the example illustrated in FIG. 10, the plates are joined by sliding them together using the flanges. That is, the first plate 402 and the third plate 422 slide together so that the flange on each plate receives the longitudinal edge without a flange from the opposing plate. Similarly, the second plate 412 and the fourth plate 432 slide together so that the flange on each plate receives the longitudinal edge without a flange from the opposing plate.

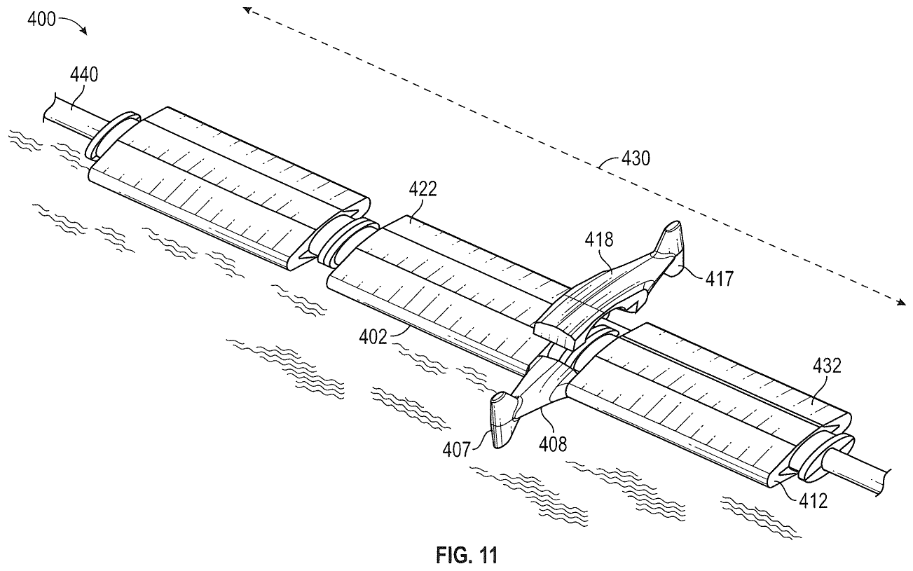

After sliding the plates together as illustrated in FIG. 10, tubercle assemblies are attached to the plates as illustrated in FIGS. 11 and 12. In the example of FIGS. 11 and 12, the tubercle assembly comprises a first tubercle 408 and a second tubercle 418 that attach on opposing sides at the first joint 409, the second joint 419, the third joint 429, and the fourth joint 439. The first tubercle 408 and the second tubercle 418 can be secured together by fasteners or various snap fit mechanisms. Once the tubercle assembly is secured to the plates, the plates are secured to the marine tubular 440. Preferably, the stabilizer 400 is free to rotate about the tubular 440 once secured to the tubular to minimize twisting or damage to the tubular 440.

FIG. 12 is a bottom view of the stabilizer 400 showing that the plates and tubular assemblies have generally the same shape on the top and bottom of the stabilizer 400. As shown in FIG. 12, another tubercle assembly comprising a third tubercle 428 and a fourth tubercle 438 can be attached at the other lateral end of the first plate 402 and the third plate 422. The tubercle assemblies in the example of FIGS. 9-12 have vertically oriented fins 407, 417, 427, and 437 extending downward from the ends of the tubercle assemblies. The fins serve to elevate the tubercle assembly and the stabilizer 400 above the seabed or shoreline to enable ocean water to flow below the stabilizer 400, thereby minimizing lift forces that may cause the stabilizer and tubular to shift.

Similar to the previous embodiments, the surfaces of the plates and the tubercle assemblies in stabilizer 400 have smooth hydrodynamic contours to minimize drag as ocean currents flow over and under the stabilizer 400. Additionally, the plates and the tubercle assemblies can distribute weight towards the outer edges farthest from the longitudinal axis 430 to increase the moment arm of the stabilizer and thereby inhibit overturning of the stabilizer 400.

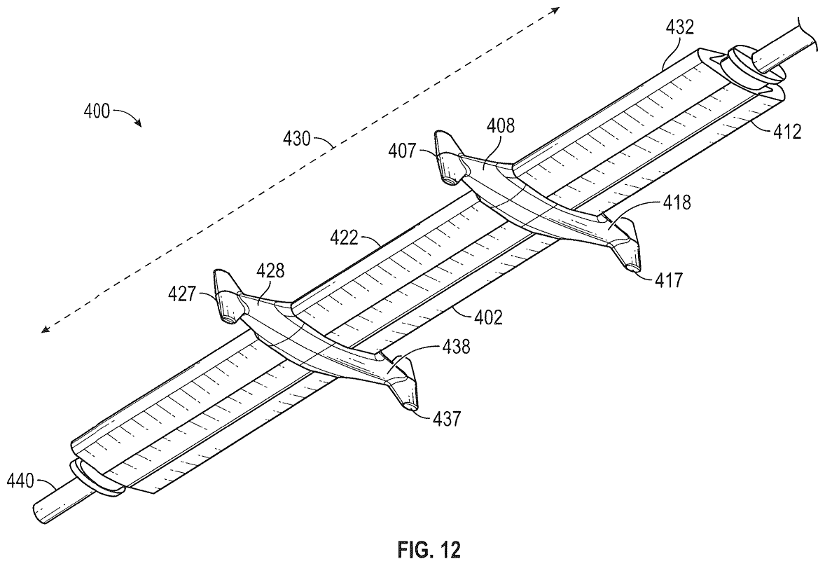

FIG. 13 illustrates an alternate embodiment for a stabilizer that is similar to the stabilizer 400 of FIGS. 9-12. The alternate embodiment of FIG. 13 differs from the previous embodiment in that the tubercle assembly 508 is wider along the longitudinal axis 530, however, the principles of operation of stabilizer 500 of FIG. 13 is generally similar to the stabilizer of FIGS. 9-12. Accordingly, the previous description of the features of stabilizer 400 can apply to the stabilizers illustrated in FIG. 13.

FIG. 13 shows stabilizer 500 attached to a marine tubular 540. As in the previous description, the stabilizer 500 can be attached to the marine tubular 540 in a variety of settings, including at a staging area, on a tubular laying vessel, or in a retrofit to a marine tubular that is already located on a seabed or a shore crossing area. The stabilizer 500 comprises a first plate 502 attached to a third plate 522 on opposite sides of the tubular 540 and a second plate 512 attached to a fourth plate 532 on opposite sides of the tubular 540. The first, second, third, and fourth plates generally have the same shapes and surfaces on their outer and inner surfaces. The stabilizer 500 also comprises tubercle assembly 508 extending from the longitudinal edges of the stabilizer 500. As can be seen in FIG. 13, the plates and the tubercle assembly have hydrodynamic contoured surfaces that minimize drag as ocean currents pass over and under the stabilizer. The tubercle assembly has vertically oriented fins 507 and 517 extending downward to elevate the stabilizer 500 off the seabed or shoreline thereby promoting stability by allowing water to flow under the stabilizer.

FIG. 14 illustrates an alternate embodiment for a stabilizer that is similar to the stabilizer 400 and the stabilizer 500, except that instead of two plates that are joined together, stabilizer 600 of FIG. 14 is a single, integrated device. The single, integrated stabilizer 600 can slide onto a marine tubular. Alternatively, the single, integrated stabilizer 600 can have a flexible opening that allows the stabilizer to snap onto a marine tubular. Otherwise, the principles of operation of stabilizer 600 of FIG. 14 are generally similar to the previously described example stabilizers in that it minimizes the hydrodynamic forces to which the marine tubular is subjected and inhibits displacement of the marine tubular. Accordingly, the descriptions and advantages of the previous example stabilizers can apply to the stabilizer 600 illustrated in FIG. 14.

FIG. 14 shows stabilizer 600 attached to a marine tubular 640. As in the previous description, the stabilizer 600 can be attached to the marine tubular 640 in a variety of settings, including at a staging area, on a tubular laying vessel, or in a retrofit to a marine tubular that is already located on a seabed or a shore crossing area. Instead of a pair of plates as in the previous examples of stabilizers, stabilizer 600 comprises a sleeve 670 that extends along a longitudinal axis 630 of the stabilizer. The sleeve 670 comprises an outer surface and an inner surface. The inner surface of the sleeve comprises a conduit 672 into which the marine tubular fits and is secured. The stabilizer 600 also comprises a tubercle 608 extending from the longitudinal edges 606 of the stabilizer 600. The longitudinal edges can be referred to as a first longitudinal edge and a second longitudinal edge. As can be seen in FIG. 14, the sleeve 670 and the tubercle 608 have hydrodynamic contoured surfaces that minimize drag as ocean currents pass over and under the stabilizer. The tubercle also has vertically oriented fins 607 and 617 extending downward from opposite ends (a first end and a second end) of the tubercle 608. The fins serve to elevate the stabilizer 600 off the seabed or shoreline thereby promoting stability by allowing water to flow under the stabilizer. The fins also can be beneficial in that they have narrow bottom ends which easily sink into the sand of the seabed further stabilizing the stabilizer.

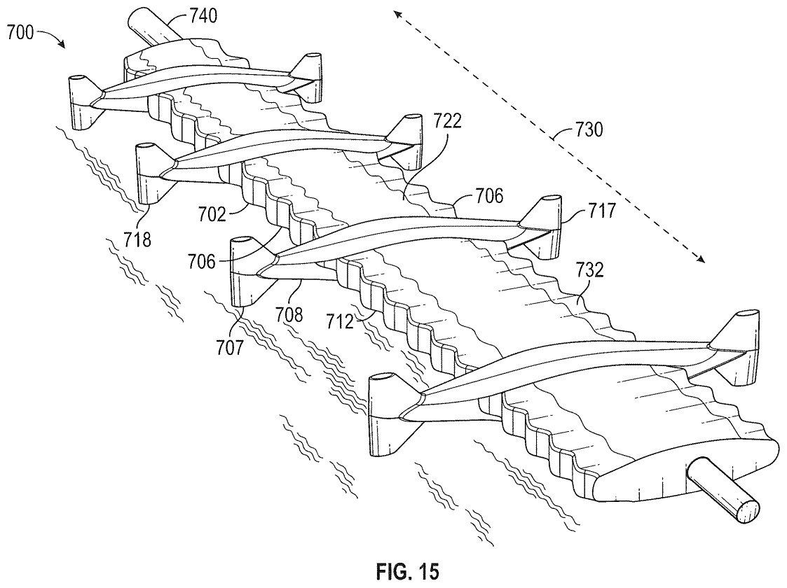

FIG. 15 shows yet another embodiment of a stabilizer 700. Stabilizer 700 of FIG. 15 is similar to example stabilizer 400 of FIGS. 9-12 except that the longitudinal edges of the stabilizer have an undulating shape similar to example 300 of FIG. 8. Stabilizer 700 comprises a series of plate pairs attached to marine tubular 740. For illustration, the stabilizer 700 comprises a first plate 702 that has an outer surface, an inner surface, a pair of opposing lateral edges on the shorter ends of the first plate 702, and a pair of longitudinal edges 706 on the longer ends of the first plate 702. The undulating shape of the longitudinal edges 706 inhibits vortices from forming when currents pass over the stabilizer thereby improving stabilization. Similar to the previous embodiments, the inner surface includes a first channel that runs along the longitudinal axis 730 of the stabilizer 700 and into which a portion of a marine tubular can fit. The first channel can have a semicylindrical shape or other similar shapes configured to secure a marine tubular.

While not required to have an adjacent set of plates, in the example stabilizer 700 includes an adjacent plate referred to as a second plate 712 that is generally similar in shape to first plate 702. The second plate 712 that has an outer surface, an inner surface, a pair of opposing lateral edges on the shorter ends of the second plate 412, and a pair of undulating longitudinal edges on the longer ends of the second plate 712. Similar to the previous embodiments, the inner surface includes a second channel that runs along the longitudinal axis 730 of the stabilizer 700 and into which a portion of a marine tubular can fit. The second channel can have a semicylindrical shape or other similar shapes configured to secure a marine tubular.

FIG. 15 also illustrates a third plate 722 joined to the first plate 702 and a fourth plate 732 that has been joined to the second plate 712 to form the stabilizer 700. The third plate 722 and fourth plate 732 are generally similar to the first plate 402 and the second plate 412. The third plate 722 has an outer surface, an inner surface, a pair of opposing lateral edges on the shorter ends of the third plate, a pair of undulating longitudinal edges on the longer ends of the third plate, and a third channel on the inner surface along the longitudinal axis 730 of the stabilizer 700. Similarly, the fourth plate 732 has an outer surface, an inner surface, a pair of opposing lateral edges on the shorter ends of the fourth plate, a pair of undulating longitudinal edges on the longer ends of the fourth plate, and a fourth channel on the inner surface along the longitudinal axis 730 of the stabilizer 700. The first and third plates and the second and fourth plates can be joined using any of the mechanisms described previously including flanges, fasteners, and bands.

After joining the plates together as illustrated in FIG. 15, tubercles, similar to those previously described, are attached to the plates. In the example of FIG. 15, the stabilizer includes multiple tubercles, including first tubercle 708 and second tubercle 718. The tubercles in the example of FIG. 15 have vertically oriented fins, such as first fin 707 and second fin 717 extending downward from the ends of the tubercle assemblies. The fins serve to elevate the tubercle assembly and the stabilizer 400 above the seabed or shoreline to enable ocean water to flow below the stabilizer 400, thereby minimizing lift forces that may cause the stabilizer and tubular to shift. The fins also can assist with stabilization by penetrating into sandy portions of the seabed.

Similar to the previous embodiments, the surfaces of the plates and the tubercle assemblies in stabilizer 700 have smooth hydrodynamic contours to minimize drag as ocean currents flow over and under the stabilizer 700. Additionally, the plates and the tubercle assemblies can distribute weight towards the outer edges farthest from the longitudinal axis 730 to increase the moment arm of the stabilizer and thereby inhibit overturning of the stabilizer 700.

For any figure shown and described herein, one or more of the components may be omitted, added, repeated, and/or substituted. Additionally, it should be understood that in certain cases components of the example systems can be combined or can be separated into subcomponents. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein unless specifically indicated by the context. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A stabilizer for a marine tubular, the stabilizer comprising:
a first plate comprising an outer surface, an inner surface, a pair of longitudinal edges, and a pair of lateral edges, wherein the inner surface comprises a first channel extending along a longitudinal axis of the stabilizer, and wherein at least one longitudinal edge of the pair of longitudinal edges comprises a first plurality of tubercles extending from the at least one longitudinal edge;
a second plate comprising an outer surface, an inner surface, a pair of longitudinal edges, and a pair of lateral edges, wherein the inner surface comprises a second channel extending along the longitudinal axis of the stabilizer; and
a fastening mechanism that joins the first plate and the second plate about the marine tubular, wherein the marine tubular fits into the first channel of the first plate and the second channel of the second plate.

2. The stabilizer of claim 1,
wherein at least one longitudinal edge of the pair of longitudinal edges of the second plate comprises a second plurality of tubercles extending from the at least one longitudinal edge of the second plate, and
wherein, when the first plate and the second plate are joined by the fastening mechanism, the first plurality of tubercles and the second plurality of tubercles extend from opposite sides of the stabilizer.

3. The stabilizer of claim 2,
wherein the first plurality of tubercles form first ridges on the outer surface of the first plate, and
wherein the second plurality of tubercles form second ridges on the outer surface of the second plate.

4. The stabilizer of claim 3, wherein the first plurality of tubercles and the second plurality of tubercles extend in a perpendicular direction relative to the longitudinal axis of the stabilizer.

5. The stabilizer of claim 2, wherein the first plurality of tubercles and the second plurality of tubercles are tapered to become more narrow as they extend away from the longitudinal edges of the first plate and the second plate.

6. The stabilizer of claim 1,
wherein the fastening mechanism that joins the first plate and the second plate about the undersea tubular is selected from the group of: fasteners inserted into the first plurality of tubulars and the second plurality of tubulars, fasteners inserted into the outer surface of the first plate, and a band wrapped around the first plate and the second plate, and
wherein the fastening mechanism permits the stabilizer to rotate about the marine tubular when the stabilizer is attached to the marine tubular.

7. A method of stabilizing a marine tubular, the method comprising:
positioning a first plate on a first side of the marine tubular, wherein the first plate comprises an outer surface, an inner surface, a pair of longitudinal edges, and a pair of lateral edges, wherein the inner surface comprises a first channel extending along a longitudinal axis of the stabilizer, and wherein at least one longitudinal edge of the pair of longitudinal edges comprises a first plurality of tubercles extending from the at least one longitudinal edge;
positioning a second plate on a second side of the marine tubular, wherein the second plate comprises an outer surface, an inner surface, a pair of longitudinal edges, and a pair of lateral edges, wherein the inner surface comprises a second channel extending along the longitudinal axis of the stabilizer; and
attaching a fastening mechanism that joins the first plate and the second plate about the marine tubular, wherein the marine tubular fits into the first channel of the first plate and the second channel of the second plate.

8. The method of claim 7, wherein the stabilizer is placed onto the marine tubular on a tubular laying vessel before the marine tubular is deployed from the tubular laying vessel.

9. The method of claim 7, wherein the stabilizer is placed onto the marine tubular before the marine tubular is loaded onto a tubular laying vessel for deployment.

10. The method of claim 7, wherein the stabilizer is retrofitted onto a marine tubular that is located in the sea or at a shore crossing zone.

11. A stabilizer for a marine tubular, the stabilizer comprising:
a first plate comprising an outer surface, an inner surface, a pair of longitudinal edges, and a pair of lateral edges, wherein the inner surface comprises a first channel extending along a longitudinal axis of the tubular stabilizer, and wherein a longitudinal edge of the pair of longitudinal edges comprises a first flange;
a second plate comprising an outer surface, an inner surface, a pair of longitudinal edges, and a pair of lateral edges, wherein the inner surface comprises a second channel extending along the longitudinal axis of the tubular stabilizer, and wherein a longitudinal edge of the pair of longitudinal edges comprises a second flange; and
a tubercle assembly that wraps around the first plate and the second plate to join the first plate and the second plate about the marine tubular, wherein the marine tubular fits into the first channel of the first plate and the second channel of the second plate.

12. The stabilizer of claim 11, wherein the tubercle assembly extends horizontally from the pair of longitudinal edges of the first plate and the pair of longitudinal edges of the second plate when the marine tubular is laid on a seabed or shore zone crossing.

13. The stabilizer of claim 12, wherein the tubercle assembly comprises a first fin and a second fin, wherein the first fin and the second fin extend vertically from the tubercle assembly permitting water to flow below the stabilizer when the marine tubular is laid on a seabed or shore zone crossing.

14. The stabilizer of claim 12, wherein a bottom surface of the tubercle assembly has an inverted camber contour when the marine tubular with the attached stabilizer is laid on a seabed or shore crossing zone.

15. The stabilizer of claim 11,
wherein the first plate further comprises a first joint at a lateral edge of the first plate;
wherein the second plate further comprises a second joint at a lateral edge of the second plate; and
wherein the tubercle assembly wraps around the first joint and the second joint when joining the first plate and the second plate about the marine tubular.

16. The stabilizer of claim 11, wherein when joining the first plate and the second plate about the marine tubular,
a longitudinal edge of the first plate fits into the second flange of the second plate; and
a longitudinal edge of the second plate fits into the first flange of the first plate.

17. (canceled)

18. (canceled)

19. (canceled)

20. (canceled)

21. The stabilizer of claim 1, further comprising:
a third plate attached to the marine tubular adjacent to the second plate; and
a fourth plate attached to the marine tubular adjacent to the first plate.

22. The stabilizer of claim 11, further comprising:
a third plate attached to the marine tubular adjacent to the second plate; and
a fourth plate attached to the marine tubular adjacent to the first plate.

23-30. (canceled)
